(19) United States
(12) Patent Application Publication
(10) Pub. No.: US 2016/0164435 A1
(43) Pub. Date: Jun. 9, 2016

(54) GARMENT HAVING TRANSDUCER CAPABILITIES

(71) Applicant: LEAP TECHNOLOGY ApS, Kgs. Lyngby (DK)

(72) Inventors: Hans-Erik KIIL, Aabenraa (DK); Mohamed BENSLIMANE, Nordborg (DK); Alan POOLE, Soenderborg (DK)

(73) Assignee: LEAP TECHNOLOGY ApS, Kgs. Lyngby (DK)

(21) Appl. No.: 14/908,045

(22) PCT Filed: Oct. 30, 2013
(86) PCT No.: PCT/DK2013/050349

§ 371 Date: Jan. 27, 2016

(30) Foreign Application Priority Data
Nov. 14, 2012 (DK) PA 2012 70701

(51) Int. Cl. H02N 1/08; A41D 1/00; H02N 1/00; A41D 31/02

(52) U.S. Cl. CPC H02N 1/08; A41D 31/02; A41D 1/002; H02N 1/006

(57) ABSTRACT

The invention provides a garment having transducer capabilities and comprising an outer layer (1) of an elastically deformable and skin-friendly material, a first electrically conductive layer (3) being stretchable being attached to the outer layer, a layer of a deformable polymer film, and a second electrically conductive layer (4) attached to the polymer film. The invention provides a high strain sensing or actuating garment.

### INTRODUCTION

The invention relates to a garment having transducer capabilities and being useful e.g. for making wearable sensors or actuators, e.g. forming an integrated part of clothing etc.

### BACKGROUND OF THE INVENTION

Garment with sensors or actuators exists, e.g. for medical monitoring of a subject, for surveillance, or related purposes.

U.S. Pat. No. 7,319,895 proposes a garment for medical monitoring of a patient. The garment comprises biomedical sensors, electrical power distribution and data transmission means and means for electrical power supply and for data transfer to means external to the garment. The proposed garment includes elastic conducting yarns integrated into and distributed over the fabric of the garment. The yarns form sensors, electrical supply, or distribution means in the garment.

US2006142654 discloses a sensor system, a garment and a heart rate monitor. The sensor system is configured to establish an electric contact with the surface of the user's skin and to generate as output an electric signal proportional to a momentary value of the electrocardiogram .

Firstly, the existing garment seems to integrate a sensor structure at a specific location within the garment. For that reason, the garment must be positioned relatively precisely relative to the body. Otherwise the sensor will not provide the desired signal detection.

Secondly, the existing garment is mostly concerned with sensing electrical body signals, such as EKG or EMG signals, sensing of chemical responses, temperature and other parameters which can be detected by a single electrode or a pattern of electrodes.

### DESCRIPTION OF THE INVENTION

It is an object of embodiments of the invention to provide a garment which can sense movement and or actuate movement. Particularly, it is an object to provide garment with a completely integrated high strain sensor.

According to a first aspect, this object is met by a garment having a laminated structure comprising :
an outer layer of an elastically deformable and, the outer layer having

opposite first and second surfaces, the first surface forming an outer surface of the garment;
a first electrically conductive layer being stretchable and having opposite first and second surfaces, the first surface being attached to the second surface of the outer layer;—a film structure comprising at least one layer of an elastically deformable polymer film, the film structure having first and second opposite surfaces, the first surface being attached to the second surface of the first electrically conductive layer;
a second electrically conductive layer being stretchable and having opposite first and second surfaces, the first surface being attached to the second surface of the elastically deformable polymer film .

By this structure, the sensor and/actuator itself forms the garment, and the garment becomes capable of detecting movement or actuating movement over the entire area of the garment. Moreover, the sensing and actuation is accomplished by deformation of a deformable polymer film, and relatively high strain sensing and/or large scale actuation may be accomplished.

In use of the garment as a sensor, deformation polymer film changes the distances between the two electrically conductive layers located on opposite surfaces of the film structure. This changes the capacitance, and the

deformation can therefore be detected by adequate electronics.

In use of the garment as an actuator, application of an electrical potential difference between two electrically conductive layers located on opposite surfaces of the film structure generates an electric field leading to a force of attraction. As a result, the distance between the conductive layers changes and the change leads to compression of the elastomeric material which is thereby deformed and the garment can be moved.

Herein we refer to the use of the garment both as a sensor and as an actuator and simply use the term “garment with transducer capabilities” whereby transducer covers the function as a sensor and as an actuator.

By garment is herein meant any kind of article of clothing or generally any article which can be worn on the body of a living being including dive suits, protective suits and workwear, suits for simulation and game purposes, e.g. for recognizing gestures of a human being, sport suits such as swim suits, and for bras and underwear in general.

Additionally, garment is supposed to include any cloth in general, e.g. for use as sailcloth, canvas for various purposes, including industrial purpose such as for drive belts, for skin material on wings, or for making panels of airplanes, space shuttles, satellites etc. or for balloons, including balloons for metrological observations or other related items.

By an outer layer is meant a layer forming an outer boundary of the garment and which can therefore we arranged facing a skin surface of a living being wearing the garment. It is therefore specified to be skin-friendly. By this term is herein meant that the material which is traditionally worn in close contact with skin of a living being and which is known as a material which does not generally cause skin inflammation, rash or skin problems. Particularly, such material may be selected from the group consisting of any kind of textile, silicone materials, and generally any material considered to be skin-friendly.

The first electrically conductive layer and the second electrically conductive layer may particularly be made from a material having a resistivity which is less than 10⁻² Ωcm such as less than 10⁻⁴ Ωcm. By providing an electrically conductive layer having a very low resistivity the total resistance of the electrically conductive layer will not become excessive, even if a very long electrically conductive layer is used. Thereby, the response time for conversion between mechanical and electrical energy can be maintained at an acceptable level while allowing a large surface area of the composite, and thereby obtaining a large actuation force or fine sensing capabilities for the garment

The electrically conductive layer may preferably be made from a metal or an electrically conductive alloy, e.g. from a metal selected from a group consisting of silver, gold and nickel. Alternatively other suitable metals or electrically conductive alloys may be chosen. Since metals and electrically conductive alloys normally have a very low resistivity, the advantages mentioned above are obtained by making the electrically conductive layer from metal or from any kind of electrically conductive material, e.g. with a modulus of elasticity which is higher than that of the polymer film—i.e. the electrically conductive layer may have a higher stiffness in the elastic range than the polymer film material. The dielectric material may have a resistivity which is larger than 10¹⁰ Ωcm.

Preferably, the resistivity of the dielectric material is much higher than the resistivity of the electrically conductive layer, preferably at least 10¹⁴-10¹⁸ times higher.

In absolute terms, the electrically conductive layer may have a thickness in the range of 0.01 μm to 0.1 μm, such as in the range of 0.02 μm to 0.09 μm, such as in the range of 0.05 tm to 0.07 μm.

The first and second electrically conductive layers are specified to be stretchable. In practice this can be obtained by making the film structure with polymer films having a surface pattern of raised and depressed surface portions and by applying a corresponding one of the electrically conductive layers onto the surface pattern in a thin layer such that it follows the shape of the polymer film to which it is attached. When the film is elastically deformed, the electrically conductive layer can follow the elastic movement of the film while the pattern is stretched out until the electrically conductive layer is completely stretched.

The film structure comprises any number of layers of an elastically deformable polymer film, e.g. one, two, three, four, or five layers of the elastically deformable film either adhesively joined or simply stacked above each other to form a laminated structure. The elastically deformable film may particularly be made from a dielectric material which herein is considered to cover any material which can sustain an electric field without conducting an electric current, such as a material having a relative permittivity, ε, which is larger than or equal to 2. It could be a polymer, e.g. an elastomer, such as a silicone elastomer, such as a weak adhesive silicone or in general a material which has elatomer like characteristics with respect to elastic deformation. For example, Elastosil RT 625, Elastosil RT 622, Elastosil RT 601 all three from Wacker-Chemie could be used as a dielectric material.

In the present context the term ‘dielectric material’ should be interpreted in particular but not exclusively to mean a material having a relative permittivity, ε Γ, which is larger than or equal to 2.

In the case that a dielectric material which is not an elastomer is used, it should be noted that the dielectric material should have elastomer-like properties, e.g. in terms of elasticity. Thus, the dielectric material should be deformable to such an extent that the composite is capable of deflecting and thereby pushing and/or pulling due to deformations of the dielectric material.

The film may have a thickness between 10 μm and 200 μm, such as between 20 μm and 150 μm, such as between 30 μm and 100 μm, such as between 40 μm and 80 μm.

The film and the electrically conductive layers may have a relatively uniform thickness, e.g. with a largest thickness which is less than 110 percent of an average thickness of the film, and a smallest thickness which is at least 90 percent of an average thickness of the film. Correspondingly, the first and the second electrically conductive layers may have a largest thickness which is less than 110 percent of an average thickness of the first electrically conductive layer, and a smallest thickness which is at least 90 percent of an average thickness of the first electrically conductive layer. The electrically conductive layers may e.g. be applied to one of the polymer film layers in a very thin layer thickness by a coating technique.

A first conductor may be attached to the first electrically conductive layer in a first connection point, and the second conductor may be attached to the second electrically conductive layer in a second connection point. The conductor may be formed as an elongated body like a traditional wire or cable. In another embodiment, the conductors may be formed as pouches being circular, oval, or of another shape suitable for establishing the electrically communication with one of the electrodes.

The conductor may e.g. be highly elastically deformable such that the length of the conductor may be varied, or the conductors may at least be flexibly bendable.

A cover layer may be arranged such that it covers and protects the second connection point. The cover layer may be of a skin-friendly material, or it may be of a material suitable for a specific purpose. Particularly, the cover may be more durable than the outer layer, it may be more water tight than the outer layer, it may have a lower or higher friction than the outer layer, or it may have a different color or texture etc.

The cover may form a tab which is separate from or separable from the second surface of the second electrically conductive layer such that the tap can extend outwards from the garment and be used e.g. for attaching the garment to a product. Particularly, such a tab may enable attachment of the garment to a product without having to stitch or in any other way penetrate the layered structure of the garment. To enable an alternative way of attaching the garment to a product, or to enable making of a wearable suit from the garment by stitching, the garment may include a void portion having at most one electrically conductive layer and preferably no electrically conductive layer. This will enable stitching through the garment without destroying the electrically conductive layers and particularly without the risk of one electrically conductive layer contacting another electrically conductive layer which could lead to short-circuiting of the electrical signals carried by those layers. A visual indication on the garment may illustrate the void portions where stitching can be carried out.

As already mentioned, the film structure may comprise any number of layers of the elastically deformable polymer film. Particularly, the garment may include two layers of elastically deformable film which are separated by an intermediate electrically conductive layer structure. The primary advantage of this structure is that a potential difference may be applied between the intermediate electrically conductive layer structure and a common potential of the first and second electrically conductive layers. Particularly, the common potential may be zero, i.e. the first and second electrically conductive layers may be connected to zero or ground, whereas a high potential difference is applied to the intermediate electrically conductive layer structure. The user of the garment may thereby be protected effectively from the high electrical potential by the first and second electrically conductive layers which are directly against the outer layer and cover layer, i.e. directly against the outer surfaces of the garment. The intermediate electrically conductive layer structure may comprise at least one, and preferably two intermediate electrically conductive layers being stretchable during elastic deformation of the polymer film.

Two intermediate electrically conductive layers may be adhesively bonded by use of an electrically conductive adhesive, and in that case, an additional conductor which is connected to the intermediate electrically conductive layer structure in an intermediate connection point can be fixed in the conductive adhesive between the intermediate electrically conductive layers.

At least one of the first, the second, and the additional conductors may comprise bendable conductive elements arranged un-stretched in contact with the electrically conductive layer or conductive layer structure to which the conductor is attached. Since the conductors are un-stretched they may be stretched during deformation of the polymer film, and the conductors can thereby follow the movement of the garment in the contact points. At least one layer of an essentially un-elastic material may be arranged to reduce stretchability of at least one of the first, the second, and the intermediate connection points. This layer may be adhesively attached directly to the surface of one of the contact points or it may be included in the electrically conductive adhesive applied between the intermediate electrically conductive layers. Since the un-elastic material reduces the stretchability, it may improve the durability of the garment by reducing fatigue and stress. By un-elastic material is herein meant a material with a higher modulus of elasticity than that of the polymer film. The ratio between a modulus of elasticity of the un-elastic material and a modulus of elasticity of the film may be larger than 50, or even larger than 100 or even larger than 200.

The garment may further comprise a layer of an elastically deformable and sealing material covering the film structure, at least some of the electrically conductive layers, and the connection points. Particularly, the garment may be completely sealed in an elastically deformable sealing material preventing intrusion of water and/or vapor, dust and other contaminants. The garment may particularly facilitate stretching in one particular direction or in several particular directions, e.g. in two directions being perpendicular. Herein, the ability to stretch the garment in one direction without being able to stretch the garment in other directions is referred to as anisotropic stretching characteristics. The polymer film is already specified as being elastically deformable, and to provide the anisotropic stretching characteristics, at least one and preferably all of the electrically conductive layers may therefore have anisotropic stretching characteristics.

This can be provided by making the aforementioned surface pattern of raised and depressed surface portions with a particular shape.

The outer layer may have an elasticity complementing the anisotropic stretching characteristics. I.e. it may e.g. be more easily deformed by elastic deformation in that direction in which the conductive layers are stretchable than in other directions. The surface pattern may e.g. comprise corrugations which render the length of the electrically conductive layers in a lengthwise direction longer than the length of the composite as such in the lengthwise direction. The corrugated shape of the electrically conductive layer thereby facilitates that the garment can be stretched in the lengthwise direction without having to stretch the electrically conductive layer in that direction, but merely by evening out the corrugated shape of the electrically conductive layer.

The corrugated pattern may comprise waves forming crests and troughs extending in one common direction, the waves defining an anisotropic characteristic facilitating movement in a direction which is perpendicular to the common direction. According to this embodiment, the crests and troughs resemble standing waves with essentially parallel wave fronts. However, the waves are not necessarily sinusoidal, but could have any suitable shape as long as crests and troughs are defined. According to this embodiment a crest (or a trough) will define substantially linear contour-lines, i.e. lines along a portion of the corrugation with equal height relative to the composite in general. This at least substantially linear line will be at least substantially parallel to similar contour lines formed by other crest and troughs, and the directions of the at least substantially linear lines define the common direction. The common direction defined in this manner has the consequence that anisotropy occurs, and that movement of the composite in a direction perpendicular to the common direction is facilitated, i.e. the composite, or at least an electrically conductive layer arranged on the corrugated surface, is compliant in a direction perpendicular to the common direction.

The variations of the raised and depressed surface portions may be relatively macroscopic and easily detected by the naked eye of a human being, and they may be the result of a deliberate act by the manufacturer. The periodic variations may include marks or imprints caused by one or more joints formed on a roller used for manufacturing the film. Alternatively or additionally, the periodic variations may occur on a substantially microscopic scale. In this case, the periodic variations may be of the order of magnitude of manufacturing tolerances of the tool, such as a roller, used during manufacture of the film.

Each wave in the corrugated surface may define a height being a shortest distance between a crest and neighboring troughs. In this case, each wave may define a largest wave having a height of at most 110 percent of an average wave height, and/or each wave may define a smallest wave having a height of at least 90 percent of an average wave height. According to this embodiment, variations in the height of the waves are very small and a very uniform pattern is obtained.

According to one embodiment, an average wave height of the waves may be between ⅓ μm and 20 μm, such as between 1 μm and 15 μm, such as between 2 μm and 10 μm, such as between 4 μm and 8 μm.

Alternatively or additionally, the waves may have a wavelength defined as the shortest distance between two crests, and the ratio between an average height of the waves and an average wavelength may be between 1/30 and 2, such as between 1120 and 1.5, such as between 1/10 and 1. The waves may have an average wavelength in the range of 1 μm to 20 μm, such as in the range of 2 μm to 15 μm, such as in the range of μm to 10 μm.

A ratio between an average height of the waves and an average thickness of the film may be between 1/50 and ½, such as between ¼ and ⅓, such as between ⅓0 and ¼, such as between ½ and ⅕.

All electrically conductive layers in the garment may have identical surface patterns, and they may be arranged to provide stretchability in identical direction.

The garment may further comprise control means adapted to apply an electrical potential difference between at least one of the intermediate electrically conductive layer structures and the common potential of the first and second electrically conductive layers. As already mentioned, applying a zero potential as the common potential will have the effect of protecting the user against the potential being present on the intermediate electrically conductive layer structure.

### LIST OF DRAWINGS

FIGS. 1a and 1b FIGS. 1a and 1b illustrate a garment according to the invention;

FIG. 2 illustrates a polymer sheet for making a layer of the garment;

FIG. 3 illustrates a garment with two polymer film layers;

FIG. 4 illustrates the garment with conductors and support layers;

FIG. 5 illustrates the garment a cover forming a tab;

FIG. 6 illustrates details of one of the connection points; and

FIG. 7 illustrates garment with a plurality of conductors.

### DETAILED DESCRIPTION

It should be understood that the detailed description and specific examples, while indicating embodiments of the invention, are given by way of illustration only, since various changes and modifications within the spirit and scope of the invention will become apparent to those skilled in the art from the detailed description.

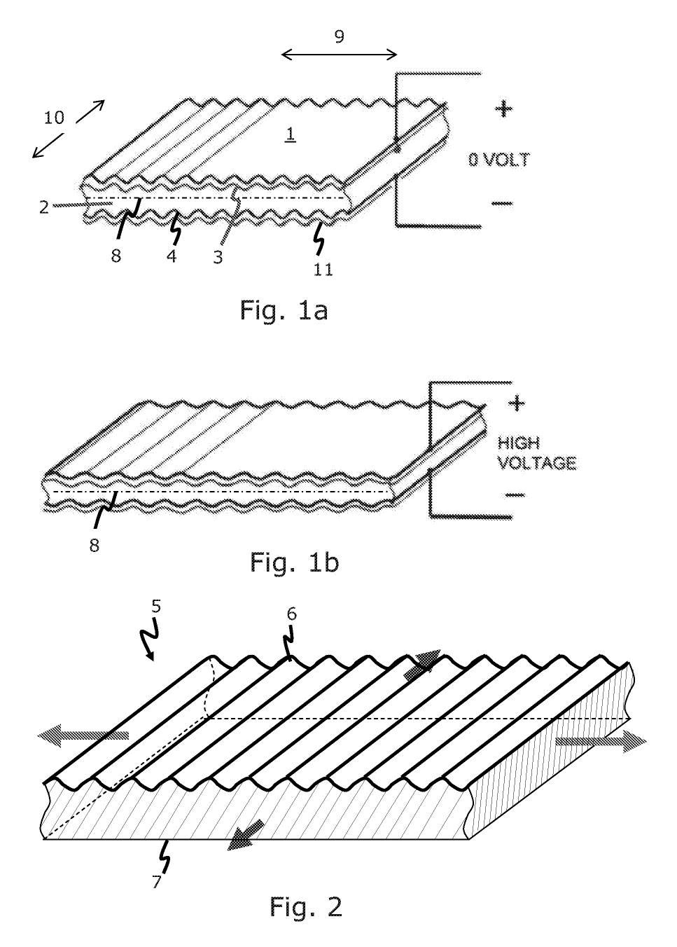

FIGS. 1a and 1b illustrate a garment comprising an outer layer 1, a film 2 of a dielectric polymer material arranged between first and second electrically conductive layers 3, 4. The first and second electrically conductive layers thereby form electrodes on opposite sides of the deformable polymer film. In FIG. 1a the garment is exposed to zero electrical potential difference, and in FIG. 1b the garment is exposed to a high electrical potential difference. As illustrated in FIG. 1b, the film 2 is expanded, while the electrically conductive layers 3, 4 are evened out, when exposed to an electrical potential difference.

FIG. 2 illustrates a sheet 5 forming part of one layer of the film structure 2. The sheet has an upper and lower surface 6, 7. The upper surface is provided with a pattern of raised and depressed surface portions thereby forming a designed corrugated profile of the surface. An electrically conductive layer has been applied to the upper surface, e.g. by a deposition technique facilitating a very low layer thickness when compared to that of the sheet. In this way, the electrically conductive layer is formed with the same pattern of raised and depressed surface portions as the upper surface of the sheet.

In terms of everyday physical things, the sheet 5 has a thickness and is pliable and soft like household film. However, it is more elastically deformable than such a film and, once the conductive layer is applied to the upper surface, it has a marked mechanical anisotropy.

Referring again to the garment in FIGS. 1a and 1b, the film structure 2 comprises a single layer of an elastically deformable polymer film. This single layer can be constituted by two of the sheets 5, each having an electrically conductive layer deposited on the upper surface. The sheets 5 are arranged with the lower surfaces 7 against each other. This is illustrated by the dotted line 8.

Due to the pattern of raised and depressed surface portions, the electrodes 3, 4 may even out as the film 2 expands, and recover its original shape as the film structure 2 contracts along the direction defined by the arrow 9 without causing damage to the electrodes 3, 4, this direction thereby defining a direction of compliance. Accordingly, the laminate 1 is adapted to form part of a compliant structure capable of withstanding deformation and large strains.

As described above, the corrugated surface profile is directly impressed or moulded into each sheet 5 of the dielectric film structure 2 before the electrically conductive layer is deposited. The corrugation allows the manufacturing of a compliant composite using a material for the electrically conductive layers having high elastic moduli, e.g. metal. This can be obtained without having to apply pre-stretch or pre-strain to the dielectric film structure 2 while applying the electrically conductive layer, i.e. the electrodes 3, 4, and the corrugated profile of the finished composite does not depend on strain in the dielectric film 2, nor on the elasticity or other characteristics of the electrodes 3, 4. Accordingly, the corrugation profile is replicated over substantially the entire upper and lower surfaces of the film structure 2 in a consistent manner, and it is possible to control this replication. Furthermore, this approach provides the possibility of using standard replication and reel-to-reel coating, thereby making the process suitable for large-scale production. For instance, the electrodes 3, 4 may be applied to the upper and lower surfaces of the dielectric film structure 2 using standard commercial physical vapour deposition (PVD) techniques. An advantage of this approach is that the anisotropy is determined by design, and that the actual anisotropy is obtained as a consequence of characteristics of the corrugated profile which is provided on the surfaces of the film structure 2 and the electrodes 3, 4 which follow the corrugated profile. The garment shown in FIGS. 1a and 1b is designed to have compliance in the direction defined by the arrow 9, and stiffness in the range of the stiffness of the electrically conductive layers 3, 4 in a direction defined by the arrow 10.

The garment comprises a cover layer 11 attached to the second surface of the second electrically conductive layer such that it covers the second connection point. The cover layer is of a skin-friendly material, it is essentially un-elastic, and it covers entirely the second surface of the second electrically conductive layer.

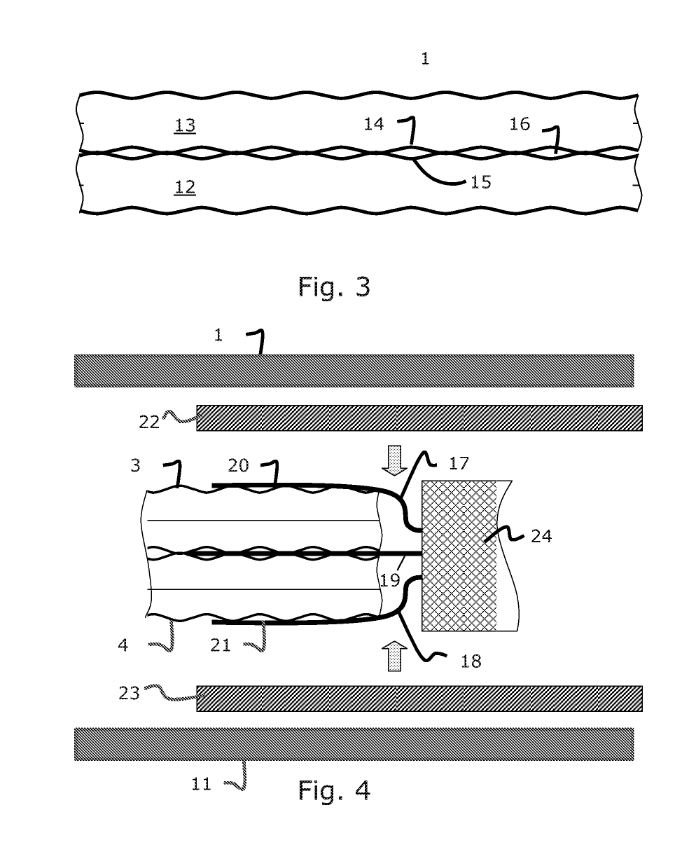

FIG. 3 illustrates a garment with two layers 12, 13 of the elastically deformable polymer film . The two layers of the film structure are separated by two intermediate electrically conductive layers 14, 15 in adhesive contact through an electrically conductive adhesive 16. The joined electrically conductive layers 14, 15 are referred to in the following as one intermediate electrically conductive layer structure 14, 15, 16. FIG. 4 illustrates how conductors can be attached to the garment for electrical communication with the electrically conductive layers. A first conductor 17, a second conductor 18, and an additional conductor 19 are in electrically conductive communication with the electrically conductive layers 3, 4, and with the intermediate electrically conductive layer structure 14, 15, 16. The contact provides connectivity to control means by which an electrical potential between the conductive layers and thereby enable deflection of the film 2 can be established. The conductors may be soft pliable and/or bendable conductors. Each of the conductors 17, 18, 19 may e.g. comprise a plurality of electrically conductive and easily bendable fibers. The areas where the conductors 17, 18, 19 are connected to the electrically conductive layers or layer structure is referred to herein as the connection points. The first and second connection points 20, 21 where the first and second electrically conductive layers 3, 4 are joined to the first and second conductors 17, 18, are covered by the outer layer 1 and by the cover layer 11. The outer layer 1 and the cover layer 11 may e.g. be of an elastically deformable material, e.g. a non-woven or woven skin-friendly material.

To strengthen the connection points and reduce the risk of fatigue and stress, the garment may comprise at least one, and preferably to additional layers, herein referred to as support layers. The support layers 22, 23 could be attached adhesively to the connection points. The support layers are made of an essentially un-elastic material, e.g. a non-woven material . The support layers thereby reduce stretchability of the garment at the connection points where the connection to the conductors may be fragile. As illustrated in FIG. 4, the support layers could be between the outer layer and the first electrically conductive layer, and between the cover layer and the second electrically conductive layer.

Alternatively, the support layers form at least one outer surface of the garment, e.g. a skin-friendly outer surface.

The first and second conductors and thus the first and second electrically conductive layers 3, 4 are connected to zero or ground of a power supply, and the intermediate conductor and conductive layer structure 13, 14, 15 is connected to different electrical potential to cause deformation of the polymer film. The connection of the outer layers to zero or ground protects the user against electric shock. The conductors form part of a soft pliable or bendable cable 24 made e.g. of a woven or non-woven fiber material.

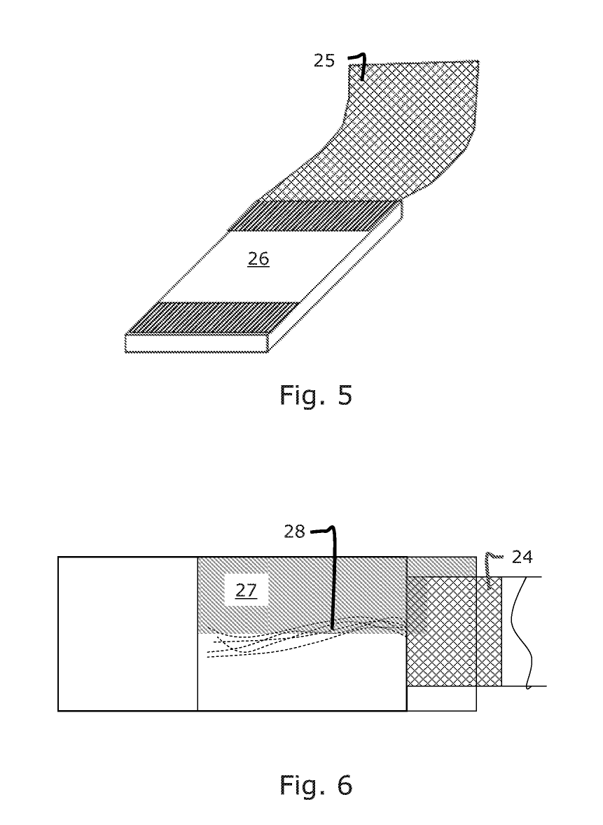

FIG. 5 illustrates that according to the invention. In this embodiment, the cover layer forms a tab 25 which is separate from or separable from the second surface 26 of the second electrically conductive layer. The tab comprises no electrically conductive layers and is therefore suitable for stitching or generally for attaching elements to the garment.

FIG. 6 illustrates one of the connection points 27 where one of the conductors comprises bendable conductive elements or fibers 28 which are arranged un-stretched in contact with the electrically conductive layer or conductive layer structure to which the conductor is attached. The un-stretched arrangement of the elements allows elastic deformation of the contact point since the elements may move until reaching a completely stretched configuration.

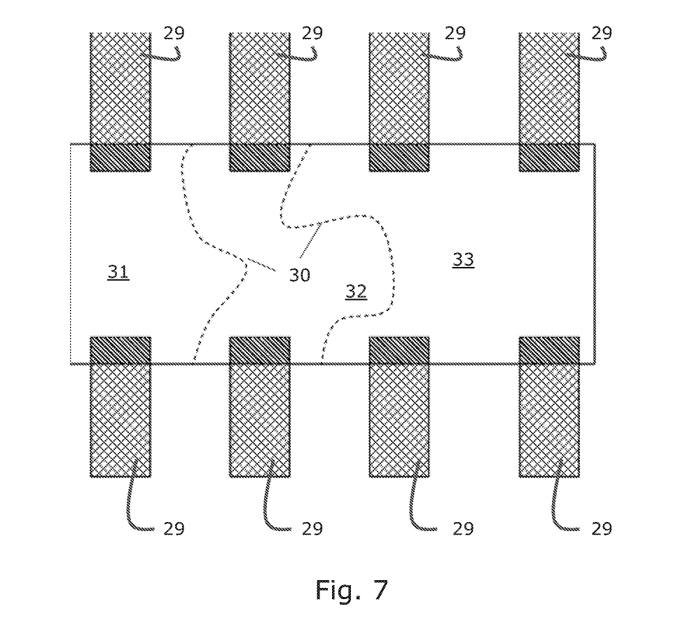

FIG. 7 illustrates a garment with a plurality of conductors 29 each having a corresponding contact point which is covered by the outer layer or cover layer, e.g. in combination with a support layer. Such a garment can be cut into a desired shape or size between the tabs.

As an example, the garment may be cut along the illustrated cut lines 30. This provides a number of separate pieces of garment 31, 32, 33, which can be connected to a control means individually via the corresponding conductors. The present invention in an alternative embodiment relates to a device having transducer capabilities and comprising:
an outer layer (1) of an elastically deformable material, the outer layer having opposite first and second surfaces, the first surface forming an outer surface of the garment;
a first electrically conductive layer (3) being stretchable and having opposite first and second surfaces, the first surface being attached to the second surface of the outer layer;
a film structure (2) comprising at least one layer of an elastically deformable polymer film, the film structure having first and second opposite surfaces, the first surface being attached to the second surface of the first electrically conductive layer;
a second electrically conductive layer (4) being stretchable and having opposite first and second surfaces, the first surface being attached to the second surface of the elastically deformable polymer film.

This device may be a garment with a skin-friendly outer layer (1), but may also be adapted to be applied in or to other objects. The outer layer (1) may be adapted either to form a platform for connecting the device to an object, such as by applying glue to the surface so that it may adhere to the object, or just by having it as a platform that mechanically may be attached to the object such as by sewing, by bolts, screws etc.

A further or alternative use of the outer layer (1) suitable for this and/or the garment embodiment is based on reducing the stretchability and/or bendability of the transducer device, such as to match the stretchability and/or bendability of the object whereto or wherein it is to be attached.

1. A garment having transducer capabilities, the garment comprising:
an outer layer of an elastically deformable and skin-friendly material, the outer layer having opposite first and second surfaces, the first surface forming an outer surface of the garment;
a first electrically conductive layer being stretchable and having opposite first and second surfaces, the first surface being attached to the second surface of the outer layer;
a film structure including at least one layer of an elastically deformable polymer film, the film structure having first and second opposite surfaces, the first surface being attached to the second surface of the first electrically conductive layer; and
a second electrically conductive layer being stretchable and having opposite first and second surfaces, the first surface being attached to the second surface of the elastically deformable polymer film.

2. A garment according to claim 1, further comprising a first conductor attached to a first connection point of the first electrically conductive layer, the first connection point being covered by the outer layer.

3. A garment according to claim 2, further comprising a second conductor attached to a second connection point of the second electrically conductive layer, the garment further comprising a cover layer having opposite first and second surfaces, the first surface being attached to the second surface of the second electrically conductive layer such that it covers the second connection point.

4. A garment according to claim 3, where the cover layer is of a skin-friendly material.

5. A garment according to claim 3, where the cover layer made of an essentially un-elastic material.

6. A garment according to claim 3, where the cover layer covers entirely the second surface of the second electrically conductive layer.

7. A garment according to claim 3, where the cover layer forms a tab which is separate from or separable from the second surface of the second electrically conductive layer.

8. A garment according to claim 1, comprising a void portion having at most one electrically conductive layer.

9. A garment according to claim 8, comprising visual indications on at least one of the first surface of the outer layer, the second surface of the second electrically conductive layer, and the second surface of the cover layer, the visual indications indicating a position of the void portion.

10. A garment according to claim 1, where the film structure includes at least two layers of the elastically deformable polymer film, adjacent layers of the elastically deformable polymer film being separated by an intermediate electrically conductive layer structure including at least one intermediate electrically conductive layer being stretchable during elastic deformation of the polymer film.

11. A garment according to claim 10, where the intermediate electrically conductive layer structure includes at least two intermediate electrically conductive layers, and an electrically conductive adhesive providing adhesive contact between the at least two intermediate electrically conductive layers.

12. A garment according to claim 10, comprising an additional conductor for each intermediate electrically conductive layer structure, each additional conductor being attached to an intermediate connection point of a corresponding one of the intermediate electrically conductive layer structures.

13. A garment according to claim 11, where at least one of the additional conductors is adhesively joined between the two intermediate electrically conductive layers by the electrically conductive adhesive.

14. A garment according to claim 2, where at least one of the first, the second, and the additional conductors comprises bendable conductive elements (28) arranged un-stretched in contact with the electrically conductive layer or conductive layer structure to which the conductor is attached.

15. A garment according to claim 1, comprising at least one layer of an essentially un-elastic material arranged to reduce stretchability of at least one of the first, the second, and the intermediate connection points.

16. A garment according to claim 1, further comprising a layer of an elastically deformable and sealing material covering the film structure, at least some of the electrically conductive layers, and the connection points.

17. A garment according to claim 1, where at least one of the first, second, and additional electrically conductive layers has anisotropic stretching characteristics provided by surface patterns on polymer film layers to which the first, second, and additional electrically conductive layers are attached.

18. A garment according to claim 17, wherein the outer layer has an elasticity complementing the anisotropic stretching characteristics.

19. A garment according to claim 1, where the first electrically conductive layer is electrically connected to the second electrically conductive layer to provide a common electrical potential on the first and second electrically conductive layers.

20. A garment according to claim 19, further comprising control means adapted to apply an electrical potential difference between at least one of the intermediate electrically conductive layer structures and the common potential of the first and second electrically conductive layers.

21. A device having transducer capabilities, the device comprising:
an outer layer of an elastically deformable material, the outer layer having opposite first and second surfaces, the first surface forming an outer surface of the garment;
a first electrically conductive layer being stretchable and having opposite first and second surfaces, the first surface being attached to the second surface of the outer layer;
a film structure including at least one layer of an elastically deformable polymer film, the film structure having first and second opposite surfaces, the first surface being attached to the second surface of the first electrically conductive layer; and
a second electrically conductive layer being stretchable and having opposite first and second surfaces, the first surface being attached to the second surface of the elastically deformable polymer film.
